(19) United States
(12) Patent Application Publication
(10) Pub. No.: US 2024/0136555 A1
(43) Pub. Date: Apr. 25, 2024

(54) Fuel Cell Cooling Control System and Method

(71) Applicants: Hyundai Motor Company, Seoul (KR); Kia Corporation, Seoul (KR)

(72) Inventor: Hyun Young Pi, Yongin-si (KR)

(21) Appl. No.: 18/337,848

(22) Filed: Jun. 19, 2023

(30) Foreign Application Priority Data
Oct. 18, 2022 (KR) 10-2022-0134535

(51) Int. Cl. H01M 8/04746; H01M 8/04029; H01M 8/0432; H01M 8/0438

(52) U.S. Cl. CPC H01M 8/04768; H01M 8/04029; H01M 8/04358; H01M 8/04395

(57) ABSTRACT

An embodiment fuel cell cooling control system including an inlet temperature sensor configured to detect a coolant inlet temperature including a temperature of a coolant supplied to a coolant inlet of a fuel cell stack, an outlet temperature sensor configured to detect a coolant outlet temperature including the temperature of the coolant discharged from a coolant outlet of the fuel cell stack, a pressure detector configured to detect a gas inlet pressure including a pressure of air supplied to a cathode-side inlet of the fuel cell stack, and a controller configured to estimate a reaction surface temperature in a cell of the fuel cell stack based on the coolant inlet temperature, the coolant outlet temperature, and the gas inlet pressure and to control a flow rate of the coolant supplied to the fuel cell stack according to the estimated reaction surface temperature.

### CROSS-REFERENCE TO RELATED APPLICATIONS

This application claims the benefit of Korean Patent Application No. 10-2022-0134535, filed on Oct. 19, 2022, which application is hereby incorporated herein by reference.

### TECHNICAL FIELD

The present disclosure relates to a fuel cell cooling control system and method.

### BACKGROUND

A fuel cell system mounted on a hydrogen fuel cell vehicle, which is one type of eco-friendly vehicle, includes a fuel cell stack that generates electric energy from an electrochemical reaction of a reaction gas (i.e., hydrogen as a fuel gas and oxygen as an oxidant gas), a hydrogen supply device that supplies hydrogen as the fuel gas, an air supply device that supplies oxygen-containing air to the fuel cell stack, a thermal management system that controls the operating temperature of the fuel cell stack, and a controller that controls the overall operation of the fuel cell system.

In the fuel cell system, the hydrogen supply device includes a hydrogen storage (hydrogen tank), a hydrogen supply line, a fuel shutoff valve, a fuel supply valve, a pressure sensor, a hydrogen re-circulator, and the like.

In addition, the air supply device includes an air supply line, an air blower or air compressor, a humidifier, an air shutoff valve, and the like, and the thermal management system includes an electric water pump (coolant pump), a coolant tank, a radiator, a 3-way valve, an ion filter, a coolant heater, and the like.

The controller (or fuel cell control unit (FCU)) controls the operations of the air compressor or air blower and electric water pump and the opening/closing operation of the fuel supply valve to control the hydrogen supply pressure, as well as the operations of other valves in the system.

In addition, unreacted hydrogen remaining after the reaction in the fuel cell stack is discharged to the outside through an anode (hydrogen electrode or fuel electrode)—side outlet, or is recirculated to an anode-side inlet of the fuel cell stack by a hydrogen re-circulator.

In addition, a purge valve for anode-side purging is installed in an anode-side exhaust line of the fuel cell stack, and the purge valve is periodically opened and closed to discharge and remove foreign substances such as nitrogen, water, etc. from the anode side of the fuel cell stack together with hydrogen, thereby increasing hydrogen utilization.

Meanwhile, as a fuel cell for a vehicle, a polymer electrolyte membrane fuel cell having high power density is most available.

Polymer electrolyte membrane fuel cells use hydrogen as a fuel gas and oxygen or air containing oxygen as an oxidant gas.

A fuel cell may include a plurality of cells that generate electric energy by reacting a fuel gas and an oxidant gas. In order to meet a required output level, it is common to use a cell stack which is formed by stacking and serially connecting a plurality of cells.

Since a fuel cell mounted on a vehicle also requires high output, hundreds of cells that individually generate electric energy are stacked in a stack form to satisfy the requirement.

A cell assembly in which a plurality of cells is stacked and connected as described above is referred to as a fuel cell stack.

The cell configuration of a polymer electrolyte membrane fuel cell includes a membrane electrode assembly (MEA) with catalyst electrode layers attached to both sides of a polymer electrolyte membrane through which hydrogen ions pass, a gas diffusion layer (GDL) that supplies the fuel gas and the oxidant gas, which are reactive gases, to the membrane electrode assembly and transfers the generated electric energy, and a separator that moves the reaction gases and the coolant.

Here, the membrane electrode assembly includes a polymer electrolyte membrane through which hydrogen ions can pass and a cathode and an anode as an electrode layer with a catalyst applied on both sides of the electrolyte membrane to promote a reaction with hydrogen as a fuel gas and air (or oxygen) as an oxidant gas.

In the unit cell of the fuel cell, the gas diffusion layer for evenly distributing the fuel gas and the oxidant gas is stacked on the outside of the membrane electrode assembly, that is, the outside of the cathode and the anode, and the separator for supplying the reaction gases to the gas diffusion layer while providing a flow path through which the reaction gases and the coolant pass is disposed on the outside of the gas diffusion layer.

In addition, a fluid-sealing gasket or the like may be interposed between the parts of the unit cell in a state of being integrally formed with the membrane electrode assembly or the separator.

The fuel cell stack is constructed by stacking the plurality of cells as unit cells having the above configuration, coupling end plates on both outermost sides of the stacked cells for supporting the cells, and fastening the end plates and the cells together using a fastening mechanism.

In addition, cooling control of the fuel cell stack is essential in order to efficiently drive the fuel cell system and maintain durability performance thereof.

In particular, in a high-temperature situation of the fuel cell stack, it is not possible to output a normal current, so it is common to perform an output-limited operation above a certain temperature.

Accordingly, the fuel cell system includes a thermal management system for controlling the temperature of the fuel cell, and the thermal management system includes a water cooling system using coolant to regulate the temperature of the fuel cell stack.

The water cooling system forms a cooling loop or a temperature-elevation loop for circulating coolant according to the temperature of the fuel cell stack.

For example, in a high-temperature situation of the fuel cell stack, the cooling loop in which low-temperature coolant that has released heat during passage through a radiator is circulated to the fuel cell stack is formed.

On the other hand, in the case where the fuel cell stack needs to elevate the temperature, such as during a cold start, the temperature-elevation loop in which the coolant discharged from the fuel cell stack is supplied back to the fuel cell stack by using a coolant pump is formed. Here, when it is required to elevate the temperature more quickly, a heater for heating the coolant is used.

In order to control a flow rate of the coolant circulating along a coolant line in a typical fuel cell system, the controller controls the rotational speed (RPM) of the coolant pump that circulates the coolant.

In this case, it is necessary to control the coolant flow rate by reflecting the operating state of the fuel cell stack as closely as possible to the actual state. For example, it is necessary to reflect the actual reaction surface temperature of the fuel cell for controlling the coolant flow rate.

Recently, in the control of a fuel cell system, since the operating conditions of the fuel cell are shifting toward high temperature and low humidity, cooling control of the fuel cell stack is becoming more important.

However, since in the related art, the rotation speed of the coolant pump and the coolant flow rate are controlled based on the temperature difference (ΔT) between the coolant outlet temperature and the coolant inlet temperature of the fuel cell, rather than the actual reaction surface temperature of the fuel cell, the cooling control of the fuel cell reflecting the actual state of the fuel cell was not performed.

As a result, heat dissipation may become insufficient during high-temperature operation, and thus the electrolyte membrane or binder of the membrane electrode assembly (MEA), which is a key component and material of the fuel cell, may be damaged due to the lack of heat dissipation, which may reduce the performance and durability of the fuel cell.

In general, the glass transition temperature of the electrolyte membrane or the binder polymer of the fuel cell is in the range of 80 to 120° C., so when the fuel cell is overheated beyond the above temperature range, the physical strength of fuel cell parts and materials, such as the electrolyte membrane or the binder, may be reduced, and thermal damage thereof may also occur.

As a result, such thermal damage may reduce proton conduction, which may result in a decreased fuel cell performance, as well as a leak, which may cause sudden death of the fuel cell.

In addition, when the temperature of the fuel cell is lower than the optimum temperature range, the performance of the fuel cell may decrease due to electrode flooding.

### SUMMARY

The present disclosure relates to a fuel cell cooling control system and method. Particular embodiments relate to a fuel cell cooling control system and method capable of reflecting an operating state of a fuel cell as closely as possible to an actual state.

Embodiments of the present disclosure can solve problems associated with the related art, and a particular embodiment of the present disclosure provides a fuel cell cooling control system and method capable of performing the fuel cell cooling control reflecting an operating state of a fuel cell as closely as possible to an actual state by estimating the reaction surface temperature of the fuel cell and using the estimated temperature in controlling a flow rate of a coolant.

An embodiment of the present disclosure provides a fuel cell cooling control system including an inlet temperature sensor configured to detect a coolant inlet temperature that is a temperature of a coolant supplied to a coolant inlet of a fuel cell stack, an outlet temperature sensor configured to detect a coolant outlet temperature that is a temperature of the coolant discharged out of a coolant outlet of the fuel cell stack, a pressure detector configured to detect a gas inlet pressure that is a pressure of air supplied to a cathode-side inlet of the fuel cell stack, and a controller configured to estimate a reaction surface temperature in a cell of the fuel cell stack on the basis of the coolant inlet temperature, the coolant outlet temperature, and the gas inlet pressure detected by the inlet temperature sensor, the outlet temperature sensor, and the pressure detector, respectively, and control a flow rate of the coolant supplied to the fuel cell stack according to the estimated reaction surface temperature.

In an embodiment, the controller may be configured to estimate the reaction surface temperature by determining a y-axis intercept value of a graph at a fixed gas inlet pressure, which corresponds to the detected coolant inlet temperature, by using a first set data preset from the detected coolant inlet temperature, determining a slope value of the graph at a variable gas inlet pressure, which corresponds to the detected gas inlet pressure, by using a second set data preset from the detected gas inlet pressure, and estimating the reaction surface temperature from the determined y-axis intercept value and slope value, the detected coolant inlet temperature, and the coolant outlet temperature.

In an embodiment, the first set data may be an equation or a map set to define a correlation between the coolant inlet temperature and the y-axis intercept values.

In an embodiment, the first set data may be defined such that the y-axis intercept value is set to be a larger value as the coolant inlet temperature increases.

In an embodiment, the second set data may be an equation or a map set to define a correlation between the gas inlet pressures and the slope values.

In an embodiment, the second set data may be defined such that the slope value is set to be a larger value as the gas inlet pressure increases.

In an embodiment, the graph at the fixed gas inlet pressure may be a graph showing a reaction surface's ΔT with respect to a coolant's ΔT, which is obtained by using the temperature value actually measured while the gas inlet pressure of the fuel cell stack is fixed in the preceding test process, where the coolant's ΔT is an actually measured temperature difference between the coolant outlet temperature and the coolant inlet temperature, and the reaction surface's ΔT is an actually measured temperature difference between an outlet temperature and an inlet temperature of the reaction surface in the cell of the fuel cell stack.

In an embodiment, the graph at the variable gas inlet pressure may be a graph showing a reaction surface's ΔT with respect to a coolant's ΔT, which is obtained by using the temperature value actually measured while the gas inlet pressure of the fuel cell stack is variable in the preceding test process, where the coolant's ΔT is an actually measured temperature difference between the coolant outlet temperature and the coolant inlet temperature, and the reaction surface's ΔT is an actually measured temperature difference between an outlet temperature and an inlet temperature of the reaction surface in the cell of the fuel cell stack.

In an embodiment, the reaction surface inlet temperature may be the temperature of a cathode reaction surface measured at the coolant inlet side of the cell, the reaction surface outlet temperature may be the temperature of the cathode reaction surface measured at the coolant outlet side of the cell, and the estimated reaction surface temperature may be an estimated temperature for the reaction surface outlet temperature.

Another embodiment of the present disclosure provides a fuel cell cooling control method including obtaining, by a controller, a coolant inlet temperature that is a temperature of a coolant supplied to a coolant inlet of a fuel cell stack from a signal of an inlet temperature sensor, obtaining, by the controller, a gas inlet pressure that is a pressure of air supplied to a cathode-side inlet of the fuel cell stack from a signal of a pressure detector, obtaining, by the controller, a coolant outlet temperature that is a temperature of the coolant discharged out of a coolant outlet of the fuel cell stack from a signal of an outlet temperature sensor, and estimating, by the controller, a reaction surface temperature in a cell of the fuel cell stack on the basis of the obtained coolant inlet temperature, coolant outlet temperature, and gas inlet pressure and controlling a flow rate of the coolant supplied to the fuel cell stack according to the estimated reaction surface temperature.

In an embodiment, the controller may be configured to estimate the reaction surface temperature by determining a y-axis intercept value of a graph at a fixed gas inlet pressure, which corresponds to the obtained coolant inlet temperature, by using a first set data preset from the obtained coolant inlet temperature, determining a slope value of the graph at a variable gas inlet pressure, which corresponds to the obtained gas inlet pressure, by using a second set data preset from the obtained gas inlet pressure, and estimating the reaction surface temperature from the determined y-axis intercept value and slope value, the obtained coolant inlet temperature, and the obtained coolant outlet temperature.

In an embodiment, the first set data may be an equation or a map set to define a correlation between the coolant inlet temperature and the y-axis intercept values.

In an embodiment, the first set data may be defined such that the y-axis intercept value is set to be a larger value as the coolant inlet temperature increases.

In an embodiment, the second set data may be an equation or a map set to define a correlation between the gas inlet pressures and the slope values.

In an embodiment, the second set data may be defined such that the slope value is set to be a larger value as the gas inlet pressure increases.

In an embodiment, the graph at the fixed gas inlet pressure may be a graph showing a reaction surface's ΔT with respect to a coolant's ΔT, which is obtained by using the temperature value actually measured while the gas inlet pressure of the fuel cell stack is fixed in the preceding test process, where the coolant's ΔT is an actually measured temperature difference between the coolant outlet temperature and the coolant inlet temperature, and the reaction surface's ΔT is an actually measured temperature difference between an outlet temperature and an inlet temperature of the reaction surface in the cell of the fuel cell stack.

In an embodiment, the graph at the variable gas inlet pressure may be a graph showing a reaction surface's ΔT with respect to a coolant's ΔT, which is obtained by using the temperature value actually measured while the gas inlet pressure of the fuel cell stack is variable in the preceding test process, where the coolant's ΔT is an actually measured temperature difference between the coolant outlet temperature and the coolant inlet temperature, and the reaction surface's ΔT is an actually measured temperature difference between an outlet temperature and an inlet temperature of the reaction surface in the cell of the fuel cell stack.

In an embodiment, the reaction surface inlet temperature may be the temperature of a cathode reaction surface measured at the coolant inlet side of the cell, the reaction surface outlet temperature may be the temperature of the cathode reaction surface measured at the coolant outlet side of the cell, and the estimated reaction surface temperature may be an estimated temperature for the reaction surface outlet temperature.

In an embodiment, the reaction surface temperature may be determined by the following Equation E1 from the y-axis intercept value, the slope value, the obtained coolant inlet temperature, and the obtained coolant outlet temperature:

e=d×(a−a′)+b+a Equation E1:

where e is the reaction surface temperature, d is the slope value, b is the y-axis intercept value, a is the coolant outlet temperature, and a′ is the coolant inlet temperature.

In an embodiment, the controller may be configured to compare the estimated reaction surface temperature with a first predetermined set temperature, and when the estimated reaction surface temperature is equal to or less than the first set temperature, to lower a rotational speed of a coolant pump to reduce the flow rate of the coolant, and when the estimated reaction surface temperature exceeds the first set temperature and is equal to or greater than a second predetermined set temperature through comparison therewith, to increase the rotational speed of the coolant pump to increase the flow rate of the coolant.

As described above, according to the fuel cell cooling control system and method of embodiments of the present disclosure, the durability of parts and materials of the fuel cell can be improved and the sudden death of the fuel cell can be prevented by estimating the reaction surface temperature of the cell rather than the coolant outlet temperature of the fuel cell stack and using the estimated reaction surface temperature in controlling the coolant flow rate.

In addition, when the coolant inlet temperature is low, the coolant flow rate can be reduced to shorten the temperature-elevation time of the fuel cell stack, and consequently, the temperature of the fuel cell stack can be quickly increased to the optimum output temperature, thereby preventing a flooding phenomenon and securing the electrode performance and durability of the fuel cell stack.

In addition, the coolant pump can be driven according to the temperature of the reaction surface of the fuel cell stack, and over-driving of the coolant pump can be prevented, thereby increasing the maximum output of the fuel cell stack.

### BRIEF DESCRIPTION OF THE DRAWINGS

FIG. 1 is a diagram illustrating the configuration of a fuel cell system to which a fuel cell cooling control method according to an embodiment of the present disclosure is applied;

FIG. 2 is a block diagram illustrating the main configuration of a fuel cell cooling control system according to an embodiment of the present disclosure;

FIG. 3 is a flowchart illustrating a fuel cell cooling control method according to an embodiment of the present disclosure;

FIG. 4 is a diagram schematically illustrating the configuration of an apparatus for measuring an actual temperature of a reaction surface in a cell of a fuel cell stack according to an embodiment of the present disclosure;

FIG. 5 is a plot illustrating the coolant's delT(ΔT) and the reaction surface's delT with respect to the coolant inlet temperature according to an embodiment of the present disclosure;

FIG. 6 is a plot illustrating the y-intercepts for the coolant inlet temperature according to an embodiment of the present disclosure;

FIG. 7 is a plot illustrating the coolant's delT(ΔT) and the reaction surface's delT with respect to the gas inlet pressure according to an embodiment of the present disclosure; and

FIG. 8 is a plot illustrating the slopes of the graphs illustrated in FIG. 7 according to an embodiment of the present disclosure.

### DETAILED DESCRIPTION OF ILLUSTRATIVE EMBODIMENTS

Hereinafter, exemplary embodiments of the present disclosure will be described in detail with reference to the accompanying drawings. Specific structural or functional descriptions presented in exemplary embodiments of the present disclosure are only exemplified for the purpose of describing the exemplary embodiments according to the concept of the present disclosure, and the exemplary embodiments according to the concept of the present disclosure may be carried out in various forms. Further, the exemplary embodiments should not be interpreted as being limited to the exemplary embodiments described in the present specification, and should be understood as including all modifications, equivalents, and substitutes included in the spirit and scope of the present disclosure.

Meanwhile, in describing embodiments of the present disclosure, terms such as first and/or second may be used to describe various components, but the components are not limited to the terms. The terms are used only for the purpose of distinguishing one component from other components. For example, a first component may be referred to as a second component, and similarly, the second component may also be referred to as the first component, without departing from the scope according to the concept of the present disclosure.

When a component is referred to as being “connected” or “coupled” to another component, it should be understood that the components may be directly connected or coupled to each other, but still other components may also exist therebetween. On the other hand, when a component is referred to as being “directly connected to” or “in direct contact with” another component, it should be understood that there is no other component therebetween. Other expressions for describing the relationship between components, that is, expressions such as “between” and “directly between” or “adjacent to” and “directly adjacent to” also should be interpreted in the same manner.

Throughout the specification, the same reference numerals refer to the same elements. Meanwhile, the terms used in the present specification are for the purpose of describing the exemplary embodiments and are not intended to limit the present disclosure. In the present specification, the singular form also includes the plural form unless otherwise specified in the phrase. “Comprises” and/or “comprising” used in the specification specifies the presence of the mentioned component, step, operation, and/or element, and does not exclude the presence or the addition of one or more other components, steps, operations, and/or elements.

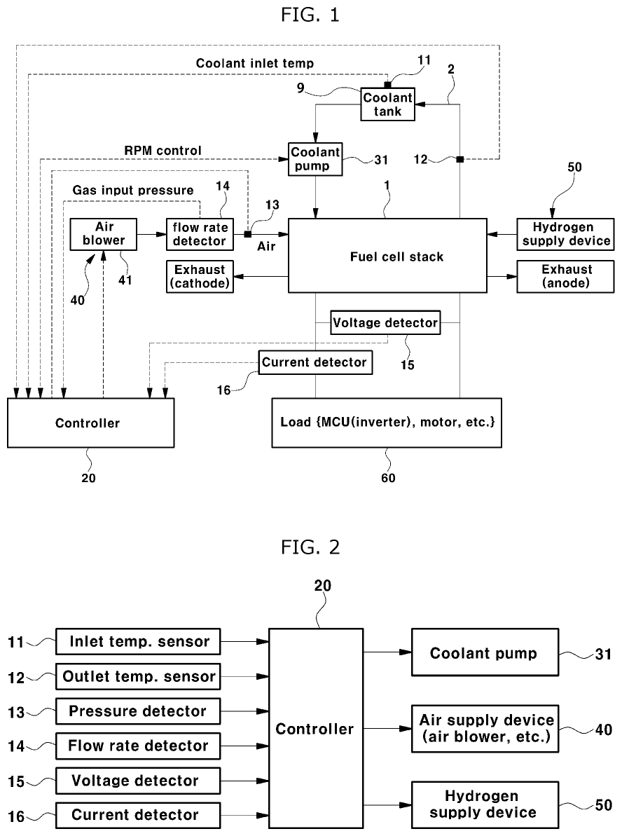

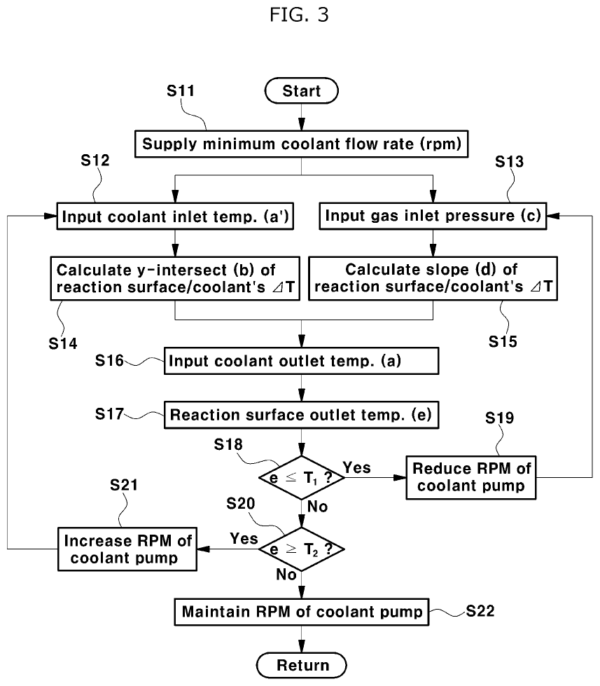

FIG. 1 is a diagram illustrating the configuration of a fuel cell system to which a fuel cell cooling control method according to an embodiment of the present disclosure is applied, FIG. 2 is a block diagram illustrating the main configuration of a fuel cell cooling control system according to an embodiment of the present disclosure, and FIG. 3 is a flowchart illustrating a fuel cell cooling control method according to an embodiment of the present disclosure.

First, as illustrated in FIG. 1, the fuel cell system includes a fuel cell stack 1 that generates electric energy from an electrochemical reaction of reaction gases (that is, hydrogen as a fuel gas and oxygen as an oxidant gas), an air supply device 40 that supplies air containing oxygen to the fuel cell stack 1, a hydrogen supply device 50 that supplies hydrogen as a fuel gas to the fuel cell stack 1, a thermal management system that controls the operating temperature of the fuel cell stack 1, and a controller 20 that controls the overall operation of the fuel cell system.

The controller 20 to be described below may be a general fuel cell system control unit (FCU) that controls the overall operation of the fuel cell system.

The air supply device 40 includes an air blower 41 that supplies air in the reaction gas to the fuel cell stack 1 through an air supply line connected to a cathode-side inlet of the fuel cell stack.

In addition, the air supply device 40 further includes a flow rate detector 14 that detects a flow rate of air supplied from the air supply line and a pressure detector 13 that detects a pressure of air supplied from the air supply line.

Since the air-supply pressure detected by the pressure detector 13 in the fuel cell system is a pressure of a reaction gas supplied to the cathode-side inlet of the fuel cell stack 1 through the air supply line, hereinafter, the air-supply pressure detected by the pressure detector 13 is referred to as a ‘gas inlet pressure’.

In a fuel cell system to which an embodiment of the present disclosure is applied, the air supply device 40 has no difference compared to the air supply device of a conventional fuel cell system, and the hydrogen supply device 50 also has no difference compared to the hydrogen supply device of the conventional fuel cell system.

In addition, the fuel cell system further includes a detection element of a conventional fuel cell system, including a voltage detector 15 that detects a voltage of the fuel cell stack 1, a current detector 16 that detects a stack output current applied from the fuel cell stack 1 to an electric load 60 of a vehicle, and the like.

In the fuel cell system, the thermal management system includes a water-cooling system that controls the temperature of the fuel cell stack 1 using a coolant circulating among a radiator (not shown), a coolant tank 9, a coolant pump 31, and the fuel cell stack 1 along a coolant line 2.

In the configuration of the cooling system, there is no difference compared to the cooling system of a conventional fuel cell system. In FIG. 1, a valve device for controlling a flow of the coolant and a cooling module for dissipating heat of the coolant to the outside, that is, a radiator and a cooling fan, are not shown.

In addition, the cooling system, as components not illustrated in FIG. 1, may further include a coolant heater for heating the coolant supplied to the fuel cell stack 1 and an ion filter for removing metal ions from the coolant that has passed through the fuel cell stack 1.

Meanwhile, the fuel cell cooling control system according to an embodiment of the present disclosure includes an inlet temperature sensor 11 for detecting a coolant inlet temperature, an outlet temperature sensor 12 for detecting a coolant outlet temperature, and the pressure detector 13 for detecting a gas inlet pressure.

In addition, the fuel cell cooling control system may further include a controller 20 that is configured to estimate the temperature of a reaction surface of the fuel cell on the basis of the coolant inlet temperature and coolant outlet temperature detected by the inlet temperature sensor 11 and the outlet temperature sensor 12, respectively, and the gas inlet pressure detected by the pressure detector 13, and control the coolant flow rate on the basis of the estimated reaction surface temperature.

Embodiments of the present disclosure can solve conventional problems in determining the coolant flow rate on the basis of the coolant inlet temperature and the coolant outlet temperature and have a main technical feature in that the coolant flow rate is controlled by estimating the reaction surface temperature.

In order to achieve the main technical feature, the present inventors derived an equation for calculating and estimating the reaction surface temperature by actually measuring the reaction surface temperature of the fuel cell under various conditions through preceding tests and analyzing the correlation between the reaction surface temperature measurement data and the coolant inlet temperature and the coolant outlet temperature, the gas inlet pressure, the coolant flow rate, etc.

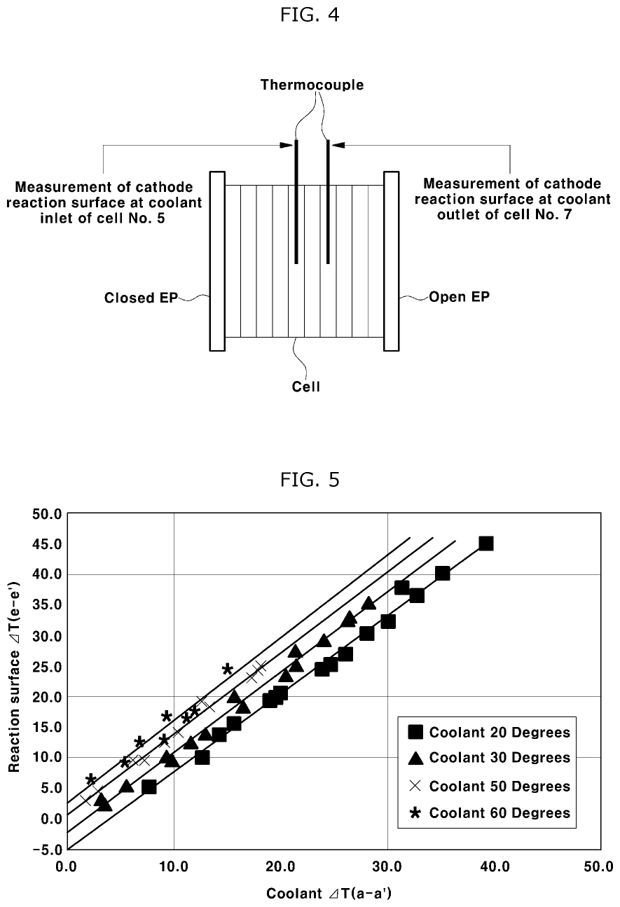

FIG. 4 is a diagram schematically illustrating the configuration of an apparatus for measuring an actual temperature of a reaction surface in a cell of a fuel cell stack. As illustrated, in the fuel cell stack 1 in which a plurality of cells is stacked between end plates, thermocouples for measuring the cathode reaction surface temperature were installed in two predetermined cells (cells Nos. 5 and 7) among all the cells.

At this time, in order to derive an equation for estimating the reaction surface temperature of the cell in the fuel cell stack 1, a T-type thin thermocouple was inserted between the cathode reaction surface and a gas diffusion layer (GDL) of the actual cell.

In addition, the temperature of the cathode reaction surface (hereinafter referred to as a ‘reaction surface inlet temperature’) was measured at the coolant inlet side of one of the two cells (‘the measurement of the cathode reaction surface at the coolant inlet of the cell No. 5’) by using a thermocouple, and the temperature of the cathode reaction surface (hereinafter referred to as a ‘reaction surface outlet temperature’) was also measured at the coolant outlet side of the other cell by using a thermocouple (‘the measurement of the cathode reaction surface at the coolant outlet of the cell No. 7’).

The reaction surface temperature estimated in embodiments of the present disclosure is an estimated temperature for the reaction surface outlet temperature.

As a result of the test, it was found that the actual reaction surface temperature in the cell of the fuel cell stack 1 was higher than the coolant outlet temperature, and that the reaction surface temperature was related not to the coolant flow rate or the current generated in the stack, but to the coolant inlet temperature and the gas inlet pressure.

In addition, the reaction surface inlet temperature e′ in the cell of the fuel cell stack 1 was the same as the coolant inlet temperature a′ of the fuel cell stack 1, and the reaction surface outlet temperature (maximum reaction surface temperature) e was measured to be higher than the coolant outlet temperature a of the fuel cell stack 1.

In addition, it can be found that the temperature difference between the coolant outlet temperature a and the coolant inlet temperature a′ of the fuel cell stack 1 (=a−a′, hereinafter referred to as a ‘coolant's ΔT’)(° C.), and the temperature difference between the reaction surface outlet temperature e and the reaction surface inlet temperature e′ (=e−e′, hereinafter referred to as a ‘reaction surface's ΔT’)(° C.) have a linear correlation.

After fixing the gas inlet pressure c (bar) of the fuel cell stack 1, the coolant's ΔT (=a-a′, coolant's delT) and the reaction surface's ΔT (=e−e′, reaction surface's delT) for each coolant inlet temperature a′ shows the same trend as in the graph at the fixed gas inlet pressure in FIG. 5. However, although the slope is similar, the correlation is such that as the value of the coolant inlet temperature a′ increases, the value of the y-axis intercept b of the graph of FIG. 5 increases.

Here, the value of the y-axis intercept b in each graph of FIG. 5 means the value of e−e′ when a−a′=0.

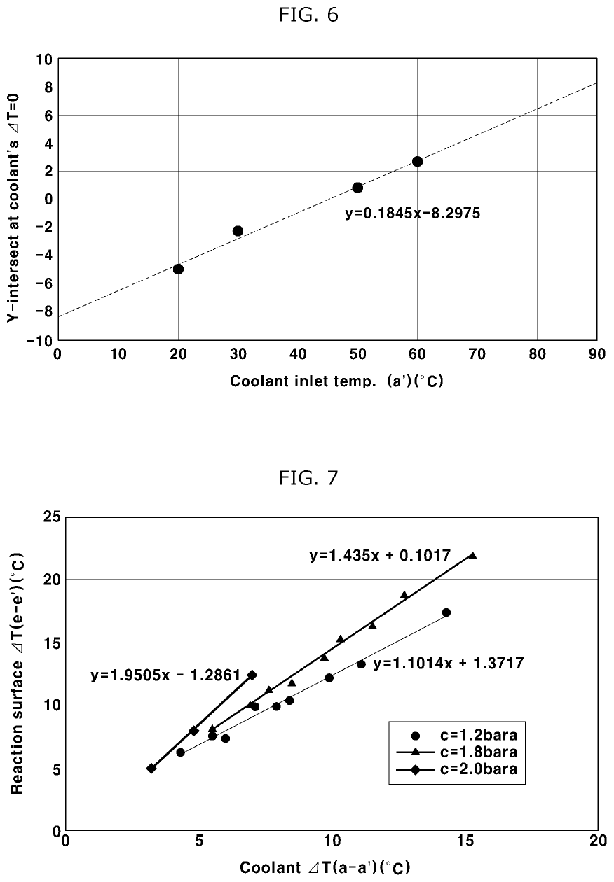

In addition, the value of the y-axis intercept b according to the coolant inlet temperature a′ is illustrated in FIG. 6.

In an embodiment of the present disclosure, the controller 20 may be configured to determine the y-axis intercept b corresponding to the current coolant inlet temperature a′ by using data as preset, input, and stored data, such as a map or an equation of the graph illustrated in FIG. 6.

In addition, the correlation between the coolant's ΔT (=a−a′) and the reaction surface's ΔT (=e−e′) according to the gas inlet pressure c under the condition of the variable gas inlet pressure c is illustrated in FIG. 7. FIG. 7 illustrates graphs at the variable gas inlet pressure, indicating the reaction surface's ΔT according to the coolant's ΔT for each gas inlet pressure c.

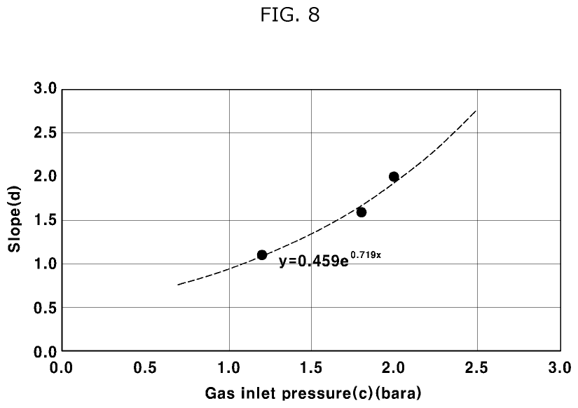

The slope d of the graph for each gas inlet pressure in FIG. 7, that is, the slope d of the reaction surface's ΔT (=e−e′) with respect to the coolant's ΔT (=a−a′) for each gas inlet pressure c is shown in FIG. 8.

That is, the slope d in FIG. 8 means the slope of the graph for each gas inlet pressure illustrated in FIG. 7, and a variation slope (change rate) of the reaction surface's ΔT according to the coolant's ΔT at the gas inlet pressure c of 1.2 bars, a variation slope of the reaction surface's ΔT according to the coolant's ΔT at the gas inlet pressure c of 1.8 bars, and a variation slope of the reaction surface's ΔT according to the coolant's ΔT at the gas inlet pressure c of 2.0 bars are shown.

As can be seen from FIG. 8, as the gas inlet pressure c increases, the slope d tends to increase.

In an embodiment of the present disclosure, the controller 20 may be configured to determine the slope d corresponding to the current gas inlet pressure c by using data as preset, input, and stored data, such as a map or an equation of the graph illustrated in FIG. 8.

In FIGS. 5 to 7, ‘delT’ represents ‘ΔT’.

When the graph of FIG. 6 is expressed as an equation, “b=0.1845×a′−8.2975”, and when the graph of FIG. 8 is expressed as an equation, “d=0.459×e′(0.719×c)”.

In addition, the following Equation 1 for calculating the reaction surface outlet temperature (maximum temperature) e can be derived from the equations for obtaining b and d.

e−e′=d×(a−a′)+b Equation 1:

where e represents the reaction surface outlet temperature (maximum temperature), and e′ represents the reaction surface inlet temperature. In addition, a represents the coolant outlet temperature, a′ represents the coolant inlet temperature, and b represents the y-axis intercept of the reaction surface's ΔT that is a value of e−e′ at a−a′=0.

Since the reaction surface inlet temperature e′ was confirmed to be the same as the coolant inlet temperature a′ from the test, the reaction surface outlet temperature (maximum temperature) e can be finally obtained from Equation 2 below.

e=d×(a−a′)+b+a Equation 2:

In addition, in order to prevent thermal deformation of an electrolyte membrane and an ionomer binder, which are key components and materials of a polymer fuel cell, it is important that the reaction surface outlet temperature e that is the maximum reaction surface temperature does not exceed the glass transition temperature of a material.

Overheating of the fuel cell with the highest reaction surface temperature above the glass transition temperature may reduce durability or cause a sudden fail of a fuel cell. The glass transition temperature T2 of a material of an electrolyte membrane and a binder of a membrane electrode assembly (MEA) and a safety temperature T1 for defining a safe range from the glass transition temperature T2 are preset, and when the reaction surface outlet temperature e is less than or equal to the safety temperature T1 that is a first set temperature, the controller 20 is configured to reduce the rotational speed (RPM) of the coolant pump 31 and the coolant flow rate.

When the reaction surface outlet temperature e reaches the glass transition temperature T2 or higher of a material as a second set temperature, the controller 20 is configured to increase the rotational speed (RPM) of the coolant pump 31 to increase the flow rate of coolant flowing through the fuel cell stack 1, thereby preventing damage of the material.

In an embodiment of the present disclosure, the glass transition temperature T2 of the fuel cell material may be selected from values in the range of 80 to 120° C., and the safety temperature T1 may be selected from values in the range of 70 to 110° C.

In this case, the safety temperature T1, which is the first set temperature, may be set to a temperature lower than the glass transition temperature T2, which is the second set temperature.

Hereinafter, a fuel cell cooling control process according to an embodiment of the present disclosure will be described with reference to FIG. 3.

First, the controller 20 controls the rotational speed of the coolant pump 31 to a preset minimum rotational speed (RPM) so that the minimum coolant flow rate can be supplied (step S11).

Next, the controller 20 obtains the current coolant inlet temperature a′ from a signal of an inlet temperature sensor 11 (step S12) and the current gas inlet pressure c from a signal of a pressure detector 13 (step S13).

Then, the controller 20 determines a corresponding y-axis intercept b from the current coolant inlet temperature a′ detected by the inlet temperature sensor 11 by using the first set data shown in FIG. 6 (step S14).

The first set data may be set such that the y-axis intercept b of the graph of FIG. 5 increases as the coolant inlet temperature a′ increases.

In addition, the controller 20 determines a corresponding slope d from the current gas inlet pressure c detected by the pressure detector 13 by using the second set data shown in FIG. 8 (step S15).

The second set data may be set such that the slope d of the graph of FIG. 7 increases as the gas inlet pressure c increases.

Then, the controller 20 obtains the current coolant outlet temperature a from a signal of an outlet temperature sensor (step S16), and using Equation 2, determines the reaction surface outlet temperature e that is the maximum reaction surface temperature (step S17).

In addition, the controller 20 compares the determined reaction surface outlet temperature e with a preset safe temperature T1 (step S18). Here, when the reaction surface outlet temperature e is equal to or less than the safe temperature T1, the controller performs a control action to reduce the rotational speed (RPM) of the coolant pump to reduce the coolant flow rate (step S19).

On the contrary, when the reaction surface outlet temperature e exceeds the safety temperature T1, the controller 20 compares the reaction surface outlet temperature with a glass transition temperature (T2) of a preset material (step S20). Here, when the reaction surface outlet temperature e is equal to or greater than the glass transition temperature T2, the controller performs a control action to increase the rotational speed (RPM) of the coolant pump from the current RPM to increase the coolant flow rate (step S21).

If, the reaction surface outlet temperature e exceeds the safety temperature T1 in step S18, but is less than the glass transition temperature T2 in step S20, the coolant flow rate and the rotational speed of the coolant pump are maintained without change (step S22).

While embodiments of the present disclosure have been described in detail, the scope of the present disclosure is not limited thereto and various modifications and improvements made by those skilled in the art using the basic concept of the present disclosure as defined in the following claims are also included in the scope of the present disclosure.

What is claimed is:

1. A fuel cell cooling control system, the system comprising:
an inlet temperature sensor configured to detect a coolant inlet temperature comprising a temperature of a coolant supplied to a coolant inlet of a fuel cell stack;
an outlet temperature sensor configured to detect a coolant outlet temperature comprising the temperature of the coolant discharged from a coolant outlet of the fuel cell stack;
a pressure detector configured to detect a gas inlet pressure comprising a pressure of air supplied to a cathode-side inlet of the fuel cell stack; and
a controller configured to:
estimate a reaction surface temperature in a cell of the fuel cell stack based on the coolant inlet temperature, the coolant outlet temperature, and the gas inlet pressure detected by the inlet temperature sensor, the outlet temperature sensor, and the pressure detector, respectively; and
control a flow rate of the coolant supplied to the fuel cell stack according to the estimated reaction surface temperature.

2. The system of claim 1, wherein the controller is configured to estimate the reaction surface temperature by determining a y-axis intercept value of a graph at a fixed gas inlet pressure which corresponds to the detected coolant inlet temperature, by using a first set data preset from the detected coolant inlet temperature, determining a slope value of the graph at a variable gas inlet pressure which corresponds to the detected gas inlet pressure, by using a second set data preset from the detected gas inlet pressure, and by estimating the reaction surface temperature from the determined y-axis intercept value, the determined slope value, the detected coolant inlet temperature, and the detected coolant outlet temperature.

3. The system of claim 2, wherein the first set data is defined such that the y-axis intercept value is set to be a larger value as the coolant inlet temperature increases.

4. The system of claim 2, wherein the second set data is defined such that the slope value is set to be a larger value as the gas inlet pressure increases.

5. The system of claim 2, wherein the graph at the fixed gas inlet pressure is a graph showing a reaction surface's ΔT with respect to a coolant's ΔT, which is obtained by using the temperature value actually measured while the gas inlet pressure of the fuel cell stack is fixed in a preceding test process, where the coolant's ΔT is an actually measured temperature difference between the coolant outlet temperature and the coolant inlet temperature, and the reaction surface's ΔT is an actually measured temperature difference between an outlet temperature and an inlet temperature of the reaction surface in the cell of the fuel cell stack.

6. The system of claim 2, wherein the graph at the variable gas inlet pressure is a graph showing a reaction surface's ΔT with respect to a coolant's ΔT, which is obtained by using the temperature value actually measured while the gas inlet pressure of the fuel cell stack is variable in a preceding test process, where the coolant's ΔT is an actually measured temperature difference between the coolant outlet temperature and the coolant inlet temperature, and the reaction surface's ΔT is an actually measured temperature difference between an outlet temperature and an inlet temperature of the reaction surface in the cell of the fuel cell stack.

7. The system of claim 6, wherein the reaction surface inlet temperature is the temperature of a cathode reaction surface measured at a coolant inlet side of the cell, a reaction surface outlet temperature is the temperature of the cathode reaction surface measured at a coolant outlet side of the cell, and the estimated reaction surface temperature is an estimated temperature for the reaction surface outlet temperature.

8. A fuel cell cooling control method, the method comprising:
obtaining, by a controller, a coolant inlet temperature comprising a temperature of a coolant supplied to a coolant inlet of a fuel cell stack from a signal of an inlet temperature sensor;
obtaining, by the controller, a gas inlet pressure comprising a pressure of air supplied to a cathode-side inlet of the fuel cell stack from a signal of a pressure detector;
obtaining, by the controller, a coolant outlet temperature comprising a temperature of the coolant discharged from a coolant outlet of the fuel cell stack from a signal of an outlet temperature sensor;
estimating, by the controller, a reaction surface temperature in a cell of the fuel cell stack based on the coolant inlet temperature, the coolant outlet temperature, and the gas inlet pressure; and
controlling, by the controller, a flow rate of the coolant supplied to the fuel cell stack according to the estimated reaction surface temperature.

9. The method of claim 8, further comprising:
determining, by the controller, a y-axis intercept value of a graph at a fixed gas inlet pressure which corresponds to the obtained coolant inlet temperature by using a first set data preset from the obtained coolant inlet temperature;
determining, by the controller, a slope value of the graph at a variable gas inlet pressure which corresponds to the obtained gas inlet pressure by using a second set data preset from the obtained gas inlet pressure; and
estimating, by the controller, the reaction surface temperature from the y-axis intercept value, the slope value, the coolant inlet temperature, and the coolant outlet temperature.

10. The method of claim 9, wherein the first set data is an equation or a map set to define a correlation between the coolant inlet temperature and the y-axis intercept value.

11. The method of claim 9, wherein the first set data is defined such that the y-axis intercept value is set to be a larger value as the coolant inlet temperature increases.

12. The method of claim 9, wherein the second set data is an equation or a map set to define a correlation between the gas inlet pressure and the slope value.

13. The method of claim 9, wherein the second set data is defined such that the slope value is set to be a larger value as the gas inlet pressure increases.

14. The method of claim 9, wherein the graph at the fixed gas inlet pressure is a graph showing a reaction surface's ΔT with respect to a coolant's ΔT, which is obtained by using the temperature value actually measured while the gas inlet pressure of the fuel cell stack is fixed in a preceding test process, where the coolant's ΔT is an actually measured temperature difference between the coolant outlet temperature and the coolant inlet temperature, and the reaction surface's ΔT is an actually measured temperature difference between an outlet temperature and an inlet temperature of the reaction surface in the cell of the fuel cell stack.

15. The method of claim 14, wherein the reaction surface inlet temperature is the temperature of a cathode reaction surface measured at a coolant inlet side of the cell, a reaction surface outlet temperature is the temperature of the cathode reaction surface measured at a coolant outlet side of the cell, and the estimated reaction surface temperature is an estimated temperature for the reaction surface outlet temperature.

16. The method of claim 9, wherein the graph at the variable gas inlet pressure is a graph showing a reaction surface's ΔT with respect to a coolant's ΔT, which is obtained by using the temperature value actually measured while the gas inlet pressure of the fuel cell stack is variable in a preceding test process, where the coolant's ΔT is an actually measured temperature difference between the coolant outlet temperature and the coolant inlet temperature, and the reaction surface's ΔT is an actually measured temperature difference between an outlet temperature and an inlet temperature of the reaction surface in the cell of the fuel cell stack.

17. The method of claim 16, wherein the reaction surface inlet temperature is the temperature of a cathode reaction surface measured at a coolant inlet side of the cell, a reaction surface outlet temperature is the temperature of the cathode reaction surface measured at a coolant outlet side of the cell, and the estimated reaction surface temperature is an estimated temperature for the reaction surface outlet temperature.

18. The method of claim 9, wherein the reaction surface temperature is determined from the y-axis intercept value, the slope value, the coolant inlet temperature, and the coolant outlet temperature using an equation e=d×(a−a′)+b+a, wherein e is the reaction surface temperature, d is the slope value, b is the y-axis intercept value, a is the coolant outlet temperature, and a′ is the coolant inlet temperature.

19. The method of claim 9, further comprising:
comparing, by the controller, the estimated reaction surface temperature with a first predetermined set temperature;
in response to the estimated reaction surface temperature being equal to or less than the first predetermined set temperature, lowering a rotational speed of a coolant pump to reduce the flow rate of the coolant; and
in response to the estimated reaction surface temperature exceeding the first predetermined set temperature and being equal to or greater than a second predetermined set temperature, increasing the rotational speed of the coolant pump to increase the flow rate of the coolant.

20. The method of claim 19, further comprising in response to the estimated reaction surface temperature exceeding the first predetermined set temperature and being less than the second predetermined set temperature, maintaining, by the controller, a current rotational speed of the coolant pump.
